(19) United States
(12) Patent Application Publication
(10) Pub. No.: US 2003/0032428 A1
(43) Pub. Date: Feb. 13, 2003

(54) System, method, and apparatus for gatekeeper networking in communication system

(76) Inventors: Yinjun Zhu, Colorado Springs, CO (US); Narayan P. Menon, Colorado Springs, CO (US)

Correspondence Address: Elsa Keller, Siemens Corporation, 186 Wood Avenue South, Iselin, NJ, 08830, US

(21) Appl. No.: 09/925,695

(22) Filed: Aug. 9, 2001

(51) Int. Cl. H04Q 7/20

(52) U.S. Cl. 455/432; 455/560; 455/435

(57) ABSTRACT

A method for gatekeeper networking includes receiving a registration message from a wireless platform serving a mobile station at a home gatekeeper of the mobile station, and instructing a telephone subsystem to forward a call directed at a telephonic device associated with the mobile station to one of the home gatekeeper of the mobile station and a roaming number assigned to the mobile station. The method also includes receiving a call setup message at the home gatekeeper of the mobile station, the call setup message representing a call involving the mobile station. The method further includes identifying a destination of the call using the call setup message, identifying a routing target associated with the destination, and communicating the call setup message to the routing target when the home gatekeeper of the mobile station is not a home gatekeeper of the destination.

### TECHNICAL FIELD

This invention relates generally to the field of communication systems, and more particularly to a system, method, and apparatus for gatekeeper networking in a communication system.

### BACKGROUND

In private communications networks and other networks, a gatekeeper is typically responsible for routing telephone calls through the network. For example, a gatekeeper may track the location of an endpoint, such as a mobile station, in the network. As the mobile station roams or moves in the network, the gatekeeper typically updates the location of the mobile station. When the gatekeeper receives a telephone call directed at the mobile station, the gatekeeper may route the call to the current location of the mobile station in the network, helping to ensure that a roaming mobile station may receive the call.

A typical gatekeeper may communicate with and serve a limited number of mobile stations in a limited area. For example, a gatekeeper may be able to serve five thousand mobile stations. As a result, multiple gatekeepers may be needed in a communication system. For example, systems with large numbers of mobile stations and/or geographically dispersed mobile stations may need multiple gatekeepers to manage communications with the mobile stations. Typical gatekeepers lack an efficient mechanism to communicate with one another and handle roaming mobile stations.

### SUMMARY

In accordance with the present invention, a system, method, and apparatus for gatekeeper networking in a communication system are provided that substantially eliminate or reduce disadvantages and problems associated with conventional systems. In particular, a mobile station is associated with a home gatekeeper, and the home gatekeeper may communicate with other gatekeepers to handle the mobile station when roaming.

In one embodiment of the invention, a method for gatekeeper networking includes receiving a registration message from a wireless platform serving a mobile station at a home gatekeeper of the mobile station, and instructing a telephone subsystem to forward a call directed at a telephonic device associated with the mobile station to one of the home gatekeeper of the mobile station and a roaming number assigned to the mobile station. The method also includes receiving a call setup message at the home gatekeeper of the mobile station, the call setup message representing a call involving the mobile station. The method further includes identifying a destination of the call using the call setup message, identifying a routing target associated with the destination, and communicating the call setup message to the routing target when the home gatekeeper of the mobile station is not a home gatekeeper of the destination.

Numerous technical advantages are provided according to various embodiments of the present invention. Particular embodiments of the invention may exhibit none, some, or all of the following advantages depending on the implementation. For example, in one embodiment, a method for gatekeeper networking is provided. In a particular embodiment, an endpoint such as a mobile station is associated with a home gatekeeper. The home gatekeeper may receive each call setup message initiated by the mobile station. The call setup message may indicate that the mobile station is attempting to initiate a call to a destination. The home gatekeeper may identify a target where the call setup message should be routed in the system, such as a home gatekeeper associated with the destination. The home gatekeeper of the destination may also receive the message and identify a target where the call setup message should be routed, such as another gatekeeper serving an area in which the destination is located. In this way, the gatekeepers may communicate with one another in the communication system and route calls to an appropriate location in the system. This also helps to ensure that the gatekeepers may support and provide services to a mobile station, even when the mobile station is out of the area served by its home gatekeeper.

Another advantage of at least some embodiments of the invention is that the gatekeeper may provide more features and services to the mobile station. For example, in one embodiment, the mobile station may be associated with a telephonic device in a telephone subsystem. As a particular example, a mobile station of an employee may be associated with the desk telephone of the employee. When the mobile station registers with the home gatekeeper, the home gatekeeper may instruct the telephone subsystem to forward calls directed at the desk telephone to an appropriate location in the system. For example, the home gatekeeper may instruct the telephone subsystem to forward calls directed at the desk telephone to the home gatekeeper, and the home gatekeeper may then route the calls to the mobile station. In this manner, calls for the employee are directed at the employee's mobile station, helping to ensure that the employee may be reached even when away from the desk telephone. This also helps to ensure that the home gatekeeper of the mobile station may seamlessly provide services to the mobile station, even when the mobile station is roaming in the network.

Other technical advantages are readily apparent to one of skill in the art from the attached figures, description, and claims.

### BRIEF DESCRIPTION OF THE DRAWINGS

To provide a more complete understanding of the present invention and features and advantages thereof, reference is made to the following description in conjunction with the accompanying drawings, in which:

FIG. 1 is a block diagram illustrating an example communication system including networked gatekeepers;

FIG. 2 is a block diagram illustrating an example home gatekeeper table in an integrated communications server of the communication system of FIG. 1;

FIG. 3 is a block diagram illustrating an example home gatekeeper table in a wireless platform of the communication system of FIG. 1;

FIG. 4 is a block diagram illustrating an example number routing table in a gatekeeper of the communication system of FIG. 1;

FIG. 5 is a block diagram illustrating an example extension number table in a gatekeeper of the communication system of FIG. 1;

FIG. 6 is a block diagram illustrating an example call routing table in a gatekeeper of the communication system of FIG. 1;

FIG. 7 is a block diagram illustrating an example gatekeeper zone table in a gatekeeper of the communication system of FIG. 1;

FIG. 8 is a block diagram illustrating an example set of signaling and bearer messages in the communication system of FIG. 1;

FIG. 9 is a block diagram illustrating another example set of signaling and bearer messages in the communication system of FIG. 1;

FIG. 10 is a flow diagram illustrating an example method for location updating;

FIG. 11 is a flow diagram illustrating another example method for location updating;

FIG. 12 is a flow diagram illustrating an example method for performing a call setup in a communication system; and

FIG. 13 is a flow diagram illustrating an example method for determining a target for a call setup message in a communication system.

### DETAILED DESCRIPTION OF EXAMPLE EMBODIMENTS

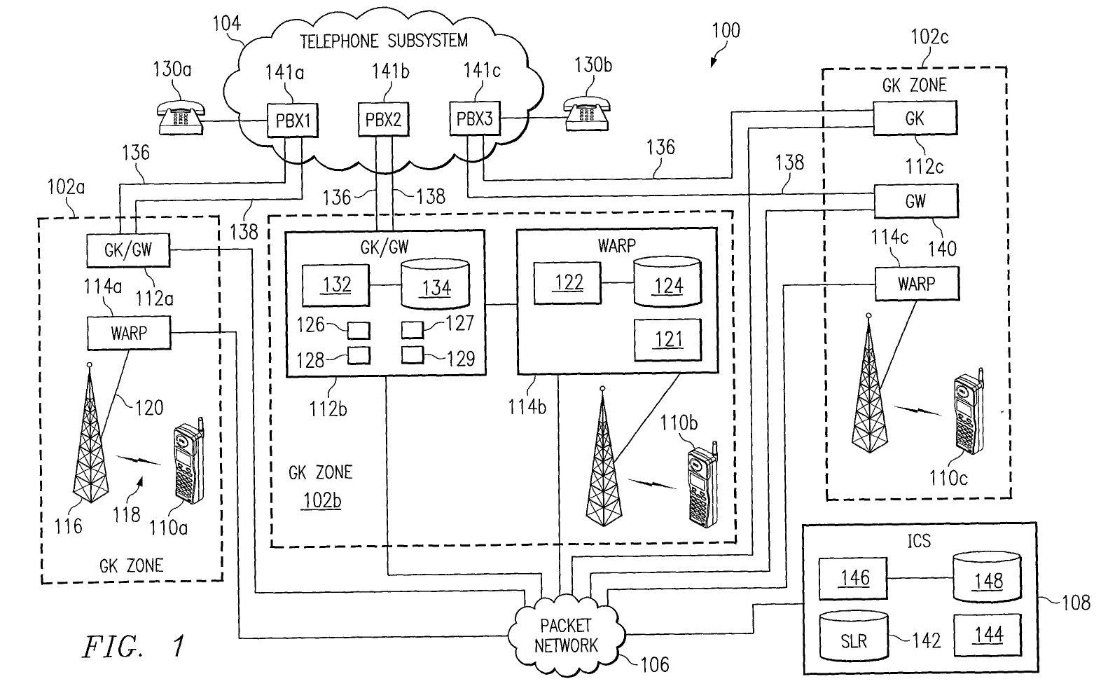

FIG. 1 is a block diagram illustrating an example communication system 100 including networked gatekeepers 112. In the illustrated embodiment, system 100 includes at least two gatekeeper zones 102, a telephone subsystem 104, a packet network 106, and an integrated communications server (ICS) 108. Other embodiments of system 100 may be used without departing from the scope of the present invention.

In one aspect of operation, a mobile station 110 such as a wireless telephone may roam into and communicate with system 100. A gatekeeper 112 is associated with each gatekeeper zone 102 in system 100. Gatekeepers 112 may provide call control services for mobile stations 110. For example, a gatekeeper 112 may track the location of a mobile station 110 in system 100 and route a telephone call to that mobile station 110. A mobile station 110 may be associated with a home gatekeeper 112 in system 100. In this document, the phrase “home gatekeeper” refers to a particular gatekeeper 112 assigned to serve a particular mobile station 110 and/or containing primary service level agreement (SLA) or other information for the mobile station 110. The phrase “home gatekeeper zone” refers to the gatekeeper zone 102 served by the home gatekeeper 112. The phrase “agent gatekeeper” refers to a particular gatekeeper 112 that serves the gatekeeper zone 102 in which a roaming mobile station 110 is located, and the phrase “agent gatekeeper zone” refers to the gatekeeper zone 102 served by the agent gatekeeper 112. The home gatekeeper 112 of a mobile station 110 handles the call setup messages for that mobile station 110. For example, when a mobile station 110 places a telephone call, a call setup message is communicated to the home gatekeeper 112 of mobile station 110, even if the mobile station 110 is in an agent gatekeeper zone 102. Home gatekeeper 112 processes the message and routes it to an appropriate destination, such as another gatekeeper 112 in system 100. When another device places a call to a mobile station 110, the home gatekeeper 112 of mobile station 110 receives the call setup message and routes it to an appropriate destination, such as another gatekeeper 112 in system 100. In this manner, the home gatekeeper 112 of a mobile station 110 handles the call setup messages for that mobile station 110, without regard to the gatekeeper zone 102 in which the mobile station 110 is currently located. This allows gatekeepers 112 to more efficiently communicate with one another and route telephone calls through system 100.

In the illustrated embodiment, each gatekeeper zone 102 includes a gatekeeper 112, at least one wireless platform such as a wireless adjunct internet platform (WARP) 114, and at least one base station 116. Other embodiments of gatekeeper zone 102 may be used without departing from the scope of the present invention.

Mobile station 110 communicates with base station 116 over a wireless interface 118. Mobile station 110 may comprise any suitable wireless device operable to communicate with and roam within system 100. Mobile station 110 may, for example, comprise a mobile telephone or a computer coupled to a wireless modem or radio unit. Mobile station 110 may communicate with system 100 using any suitable protocols, such as Global System for Mobile communication (GSM) protocols. Mobile station 110 may also comprise a dual mode mobile station operable to communicate with system 100 using a first protocol and with a public network using a second protocol. For example, mobile station 110 may comprise a dual mode GSM/IS-138 mobile handset. Other embodiments of mobile station 110 may be used without departing from the scope of the present invention. Also, system 100 may be described as communicating with mobile stations 110, which may include any suitable endpoint. In addition, while system 100 may be described as routing voice calls to and from mobile stations 110, calls involving the transport of facsimile traffic, video-conferencing traffic, and/or any other suitable type of traffic may be used in system 100.

Base station 116 is coupled to WARP 114. In this document, the term “couple” refers to any direct or indirect communication between two or more elements, whether or not those elements are in physical contact with one another. Base station 116 provides bi-directional communication with mobile stations 110 in a specified geographic area over wireless interface 118. Base station 116 also transfers information between mobile station 110 and WARP 114. Base station 116 may comprise any hardware, software, firmware, or combination thereof operable to communicate with mobile stations 110 over a wireless interface. Base station 116 may, for example, comprise one or more transceivers operable to exchange circuit-switched and/or packet-switched information with mobile station 110.

Wireless interface 118 facilitates communication between mobile station 110 and base station 116. Wireless interface 118 may comprise any wireless interface operable to transfer circuit-switched and/or packet-switched information between mobile station 110 and base station 116. Interface 118 may, for example, comprise a GSM General Packet Radio Service (GSM/GPRS) interface or a GSM Enhanced Data rates for GSM Evolution (GSM/EDGE) interface.

WARP 114 is coupled to base station 116 by an interface 120 and to packet network 106. WARP 114 facilitates communication with mobile stations 110 by transporting voice and/or data information between base station 116 and packet network 106. In one embodiment, WARP 114 communicates with mobile station 110 through base station 116 using a circuit-switched protocol, and WARP 114 communicates with packet network 106 using a packet-switched protocol. In this embodiment, WARP 114 may also perform an interworking function to translate between the circuit-switched and packet-switched protocols. For example, WARP 114 may convert between the GSM 04.08 and 08.60 protocols used by mobile station 110 and the International Telecommunications Union-Telecommunications (ITU-T) H.323 protocols used by gatekeepers 112. WARP 114 may further packetize information from mobile station 110 into datagrams for communication over packet network 106, and WARP 114 depacketizes information contained in datagrams received over packet network 106.

In addition, WARP 114 facilitates communication between mobile station 110 and a home gatekeeper 112 associated with mobile station 110. For example, when mobile station 110 enters a geographic area served by a WARP 114, WARP 114 may communicate with integrated communications server 108 and identify the home gatekeeper 112 of mobile station 110. WARP 114 may store information identifying the home gatekeeper 112 of mobile station 110 in a home gatekeeper table 121. One example of a home gatekeeper table 121 is shown in FIG. 3, which is described below. WARP 114 may then communicate a registration message to the home gatekeeper 112 of mobile station 110. After that, if mobile station 110 initiates an outgoing telephone call, WARP 114 accesses home gatekeeper table 121, identifies the home gatekeeper 112 of mobile station 110, and communicates a call setup message to the home gatekeeper 112.

In one embodiment, voice traffic travels between gatekeeper zones 102 through telephone subsystem 104, rather than over packet network 106. For example, packet network 106 may lack the bandwidth and/or quality of service needed to transport voice information between gatekeeper zones 102. In this embodiment, if mobile station 110 is roaming in system 100, WARP 114 may assign a roaming number to mobile station 110 during the registration process. The roaming number may be assigned from a roaming number pool managed by WARP 114 and/or integrated communications server 108. The roaming number pool contains roaming numbers that may be assigned to roaming mobile stations 110 that enter a gatekeeper zone 102. WARP 114 may also communicate a call forwarding activation message to the home gatekeeper 112 of mobile station 110. The call forwarding activation message may identify the roaming number assigned to the mobile station 110 by WARP 114. In a particular embodiment, the call forwarding activation message comprises an H.450.3 call forwarding activation message. The roaming number may be used by gatekeeper 112 and/or telephone subsystem 104 to route calls for mobile station 110 through telephone subsystem 104 to the appropriate gatekeeper zone 102, rather than setting up a call over packet network 106.

WARP 114 could determine whether voice traffic may be routed over packet network 106 using any suitable method. For example, a flag may be set in WARP 114 indicating whether voice traffic may be routed over packet network 106. In another embodiment, WARP 114 may be customized to operate in system 100. For example, WARP 114 may be configured to always assign roaming numbers to roaming mobile stations 110, or WARP 114 may be configured to never assign roaming numbers to roaming mobile stations 110. In addition, WARP 114 or another component in system 100 could dynamically check to see if packet network 106 may support voice traffic, and WARP 114 could modify its behavior based on that determination. For example, WARP 114 could communicate information over packet network 106 and measure delay, jitter, bandwidth, or any other suitable characteristics of network 106 and determine if those measurements are above threshold limits.

In a particular embodiment, the home gatekeeper 112 of roaming mobile station 110 may be unavailable when WARP 114 attempts to register the roaming mobile station 110, such as when the home gatekeeper 112 of mobile station 110 loses power. If WARP 114 cannot register a roaming mobile station 110 with the home gatekeeper 112 of mobile station 110, WARP 114 may assign a roaming number to mobile station 110 from the roaming number pool. WARP 114 may also register the roaming mobile station 110 with the gatekeeper 112 serving WARP 114. The alternate gatekeeper 112 may be able to handle outgoing calls from mobile station 110 and deliver at least some incoming calls to the mobile station 110.

WARP 114 may comprise any hardware, software, firmware, or combination thereof operable to facilitate communication between base station 116 and packet network 106. In one embodiment, WARP 114 comprises at least one processor 122 and at least one memory 124 operable to store data and instructions used by processor 122.

Interface 120 couples base station 116 and WARP 114. Interface 120 may comprise any suitable interface operable to transfer circuit-switched and/or packet-switched information between base station 116 and WARP 114. Interface 120 may, for example, comprise a GSM Abis wireline interface.

Gatekeeper 112 provides call control services for mobile stations 110. For example, a gatekeeper 112 may track the location of a mobile station 110 in its gatekeeper zone 102, and gatekeeper 112 routes calls for the mobile station 110 to the WARP 114 currently serving that mobile station 110. This allows subscribers using mobile stations 110 to roam between geographic areas covered by different base stations 116. Gatekeeper 112 also performs address translation to convert the phone number associated with mobile station 110 to a network address of WARP 114 serving that mobile station 110. For example, when gatekeeper 112 receives a call setup message representing a telephone call directed at a non-roaming mobile station 110, gatekeeper 112 may identify the network address of WARP 114 serving mobile station 110 and communicate the setup message to that address.

In one embodiment, a gatekeeper 112 may act as a home gatekeeper for a mobile station 110. In this embodiment, when a mobile station 110 registers with a WARP 114 in system 100, the home gatekeeper 112 of that mobile station 110 receives a registration message from WARP 114. The home gatekeeper 112 of mobile station 110 receives the message even when mobile station 110 is roaming in an agent gatekeeper zone 102 served by an agent gatekeeper 112. In one embodiment, the home gatekeeper 112 stores information identifying the location of mobile station 110 in an extension number table 127 and/or a call routing table 128. The extension number table 127 may, for example, map the extension number of a registered mobile station 110 to a Transport Service Access Point (TSAP) address of a WARP 114 serving mobile station 110. The TSAP address may identify the network address of the WARP 114 and a port number of WARP 114 that is associated with mobile station 110. One example of an extension number table 127 is shown in FIG. 5, which is described below. The call routing table 128 may, for example, map the network address of a WARP 114 to gatekeeper zones 102 in system 100. This allows gatekeeper 112 to identify whether the network address associated with a WARP 114 serving a mobile station 110 is in another gatekeeper zone 102. One example of a call routing table 128 is shown in FIG. 6, which is described below.

The home gatekeeper 112 of a mobile station 110 also handles call setup messages for that mobile station 110. If mobile station 110 initiates a telephone call, the WARP 114 serving mobile station 110 communicates a call setup message to the home gatekeeper 112 of mobile station 110. The call setup message may identify the phone number of the destination being called by mobile station 110. The home gatekeeper 112 receives the message and identifies where to route the message. An example method of determining where to route a setup message is illustrated in FIG. 13, which is described below.

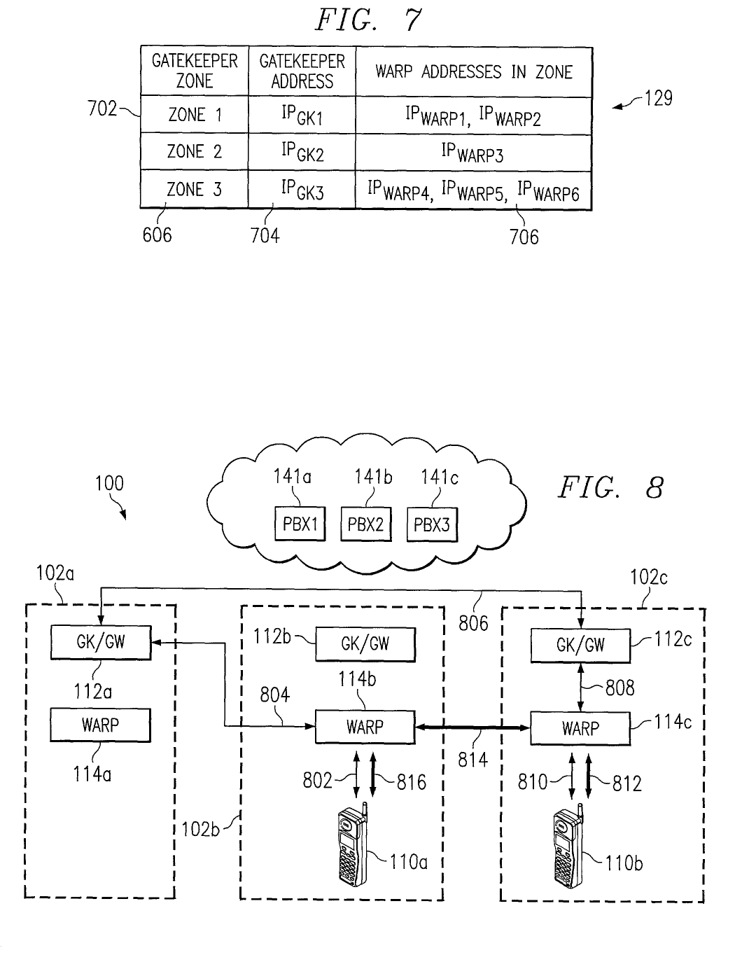

In general, gatekeeper 112 selects a target for the call setup message, and the target of the setup message may vary depending on whether packet network 106 may transport voice traffic between gatekeeper zones 102. For example, if packet network 106 may not transport voice traffic between gatekeeper zones 102, gatekeeper 112 may determine whether the call setup message came from a WARP 114 in another gatekeeper zone 102. This would indicate that the calling mobile station 110 is roaming in an agent gatekeeper zone 102. Gatekeeper 112 may use a gatekeeper zone table 129 to identify the zone 102 in which a call setup message originated. Gatekeeper zone table 129 may, for example, identify the various gatekeeper zones 102, the network address of the gatekeeper 112 serving each zone 102, and the network addresses of the WARPs 114 in each zone 102. One example of a gatekeeper zone table 129 is shown in FIG. 7, which is described below. If the setup message originated from a WARP 114 in another zone 102, gatekeeper 112 may select the gatekeeper 112 serving that zone 102 as the target for the setup message.

If the setup message did not originate from a WARP 114 in another gatekeeper zone 102, or if packet network 106 may transport voice traffic between gatekeeper zones 102, gatekeeper 112 may access a number routing table 126 to identify the target for the call setup message. Number routing table 126 may, for example, associate a numbering plan in system 100 with a routing target to which the call setup message should be routed for that numbering plan. As a particular example, number routing table 126 may indicate that calls to mobile stations 110 having extension numbers of “3xxx” should be routed to the network address of gatekeeper 112c. One example of a number routing table 126 is shown in FIG. 4, which is described below. Gatekeeper 112 accesses number routing table 126 and identifies a target associated with the destination dialed by the calling mobile station 110. If table 126 identifies the network address of another gatekeeper 112 or a path to telephone subsystem 104 as the target of the setup message, gatekeeper 112 routes the call setup message to the identified target. If the call is to be processed locally, gatekeeper 112 is the home gatekeeper 112 for the destination of the call, and gatekeeper 112 may use extension number table 127, call routing table 128, and/or gatekeeper zone table 129 to identify a target for the call setup message.

In addition, gatekeeper 112 may perform call forwarding functions in system 100. In one embodiment, one or more telephones 130 communicate with telephone subsystem 104. A mobile station 110 may be associated with one or more telephones 130, such as when a subscriber using mobile station 110 also has a desk telephone 130 in an office. In this embodiment, when a mobile station 110 registers with its home gatekeeper 112, the home gatekeeper 112 may instruct telephone subsystem 104 to forward calls directed at telephone 130 to a different location. For example, if voice traffic may be transported over packet network 106, the home gatekeeper 112 may instruct telephone subsystem 104 to forward telephone calls directed at telephone 130 to home gatekeeper 112. If voice traffic may not be transported over packet network 106, the home gatekeeper 112 may instruct telephone subsystem 104 to forward telephone calls directed at telephone 130 to the home gatekeeper 112 or to the roaming number assigned to a roaming mobile station 110. As a particular example, home gatekeeper 112 may activate a call forward unconditional (CFU) feature in telephone subsystem 104 to forward calls for the associated telephone 130. When mobile station 110 deregisters with home gatekeeper 112, home gatekeeper 112 may deactivate the call forwarding feature in telephone subsystem 104. By forwarding telephone calls to mobile station 110 when mobile station 110 registers with system 100 and unforwarding telephone 130 when mobile station 110 deregisters with system 100, gatekeeper 112 reduces or eliminates the need for a subscriber to manually forward and unforward telephone 130. Gatekeeper 112 also helps to ensure that mobile station 110 may receive the same services while in any gatekeeper zone 102.

As with WARP 114, gatekeeper 112 could determine whether voice traffic may be routed over packet network 106 using any suitable method. For example, a flag may be set in gatekeeper 112 indicating whether voice traffic may be routed over packet network 106. Gatekeeper 112 could also be customized to operate in system 100. For example, gatekeeper 112 may be configured to always check if a calling mobile station 110 is in another gatekeeper zone 102, or gatekeeper 112 may be configured to never check that. In addition, gatekeeper 112 or another element in system 100 could dynamically check to see if packet network 106 may support voice traffic, and gatekeeper 112 could modify its behavior based on that determination. For example, gatekeeper 112 could communicate information over packet network 106 and measure delay, jitter, bandwidth, or any other suitable characteristics of network 106 and determine if those measurements are above threshold limits. Gatekeeper 112 could also include multiple number routing tables 126, one to be used when packet network 106 may transport voice traffic and another to be used when packet network 106 may not.

Gatekeeper 112 may comprise any hardware, software, firmware, or combination thereof operable to provide some, all, and/or additional call control services for a mobile station 110. In one embodiment, gatekeeper 112 comprises at least one processor 132 and at least one memory 134 operable to store data and instructions used by processor 132. Gatekeeper 112 may perform the functions described above by executing steps to carry out the functions or by instructing other elements or components of system 100 to initiate performance of a function.

Gatekeeper 112 may communicate with telephone subsystem 104 using one or more interfaces. In one embodiment, gatekeeper 112 communicates with telephone subsystem 104 over a Computer Telephony Integration (CTI) interface 136. CTI interface 136 may, for example, comprise an Ethernet or an X.25 packet interface. Gatekeeper 112 may also communicate with telephone subsystem 104 over an interface 138. Interface 138 may, for example, comprise a trunk interface or a plurality of line interfaces.

Gatekeeper zone 102 may further include a gateway 140. Gateway 140 is coupled to packet network 106 and to telephone subsystem 104 by interface 138. Gateway 140 may also be coupled to a public network, such as a public switched telephone network. Gateway 140 transfers information between packet network 106 and telephone subsystem 104. In one embodiment, gateway 140 communicates with packet network 106 using a packet-switched protocol and with telephone subsystem 104 using a circuit-switched protocol. In this embodiment, gateway 140 also performs an interworking function to translate between the packet-switched and circuit-switched protocols. In a particular embodiment, gateway 140 converts between the ITU-T H.323 protocols used by WARP 114 and the circuit-switched protocols used by telephone subsystem 104. In addition, gateway 140 packetizes information into datagrams for communication over packet network 106, and gateway 140 depacketizes information contained in datagrams received over packet network 106. Gateway 140 may comprise any hardware, software, firmware, or combination thereof operable to facilitate communication between packet network 106 and telephone subsystem 104. While gatekeeper 112 and gateway 140 are illustrated in gatekeeper zone 102c as separate elements, the functionality of gateway 140 could also be incorporated into gatekeeper 112, as illustrated in gatekeeper zones 102a and 102b.

In the illustrated embodiment, telephone subsystem 104 is coupled to gatekeeper 112 and/or gateway 140. Telephone subsystem 104 may also be coupled to one or more public networks, such as a public switched telephone network (PSTN) and/or a public land mobile network (PLMN). Telephone subsystem 104 facilitates communication with telephones 130. Telephone subsystem 104 may, for example, establish a telephone call between a first telephone 130a and a second telephone 130b. Telephone subsystem 104 may also facilitate communication between a telephone 130 and a mobile station 110 by communicating with gatekeeper 112 and/or gateway 140 over interfaces 136 and/or 138. Telephone subsystem 104 may comprise any suitable hardware, software, firmware, or combination thereof operable to facilitate communication between telephone 130 and mobile station 110. In the illustrated embodiment, telephone subsystem 104 comprises one or more private branch exchanges (PBX). Telephone subsystem 104 could also comprise a Key System, a central office switch, a wireless telephone switch, a packet-based soft switch, or any other suitable circuit-switched and/or packet-switched system.

Telephone 130 is coupled to telephone subsystem 104. Telephone 130 may comprise any suitable wireline or wireless telephonic device operable to communicate with telephone subsystem 104. In this document, the phrase “telephonic device” refers to any hardware, software, firmware, or combination thereof operable to provide voice phone services. Telephone 130 may, for example, comprise a fixed telephone, a wireless mobile station, a voice over packet telephone, or a computer executing a telephonic application.

Packet network 106 is coupled to integrated communications server 108, gatekeeper 112, and WARP 114. Packet network 106 may also be coupled to gateway 140. In addition, packet network 106 may be coupled to and communicate with external data or voice networks, such as the Internet or a public land mobile network. Packet network 106 transports datagrams from one network address in packet network 106 to another network address. Packet network 106 may, for example, transport datagrams containing signaling information between WARP 114 and a home gatekeeper 112 of a mobile station 110. Packet network 106 may comprise any hardware, software, firmware, or combination thereof operable to transport information. Packet network 106 may, for example, comprise a Local Area Network (LAN), a Wide Area Network (WAN), a Metropolitan Area Network (MAN), a portion of a global computer network such as the Internet, or any other communication system or systems at one or more locations.

In one embodiment, packet network 106 may be utilized to transport voice bearer traffic between gatekeeper zones 102. In this embodiment, packet network 106 may possess the bandwidth and quality of service to transport voice information between components in system 100, such as between two WARPs 114 in different gatekeeper zones 102. In another embodiment, some or all of the voice traffic between two gatekeeper zones 102 is not transported across packet network 106. For example, packet network 106 may lack the bandwidth and/or the quality of service necessary to transport voice information between gatekeeper zones 102, or an operator of system 100 may wish to transport voice traffic between gatekeeper zones 102 without using packet network 106. Other reasons for not transporting voice traffic between gatekeeper zones 102 across packet network 106 may exist without departing from the scope of the present invention. In this embodiment, signaling messages used to set up and tear down connections may be transported across packet network 106, and the gatekeepers 112 communicate and exchange signaling messages so that voice traffic may be transported between gatekeeper zones 102 using telephone subsystem 104. In a particular embodiment, some voice traffic may be communicated over packet network 106, while other voice traffic may be communicated over telephone subsystem 104. For example, voice traffic from particular mobile stations 110 or groups of mobile stations 110 may be communicated over packet network 106. Also, mobile stations 110 or groups of mobile stations 110 may provide a lower quality of service to subscribers, and voice traffic from these mobile stations 110 may be transported over packet network 106 while traffic from other mobile stations 110 is communicated over telephone subsystem 104. Other embodiments may be used without departing from the scope of the present invention.

In the illustrated embodiment, integrated communications server 108 includes a subscriber location register (SLR) 142 and a home gatekeeper table 144. Other embodiments of integrated communications server 108 may be used without departing from the scope of the present invention. For example, although FIG. 1 illustrates subscriber location register 142 and home gatekeeper table 144 as separate components, home gatekeeper table 144 could also be incorporated into subscriber location register 142.

Subscriber location register 142 stores subscriber management information for mobile stations 110. For example, subscriber location register 142 may store general subscriber management information downloaded from a public network when mobile station 110 roams into system 100. Subscriber location register 142 also stores each subscriber's extension number, direct dial number, and any other information that is specific to system 100. Subscriber location register 142 may comprise any hardware, software, firmware, or combination thereof operable to store subscriber management information. Subscriber location register 142 may, for example, comprise a SUN workstation with a database.

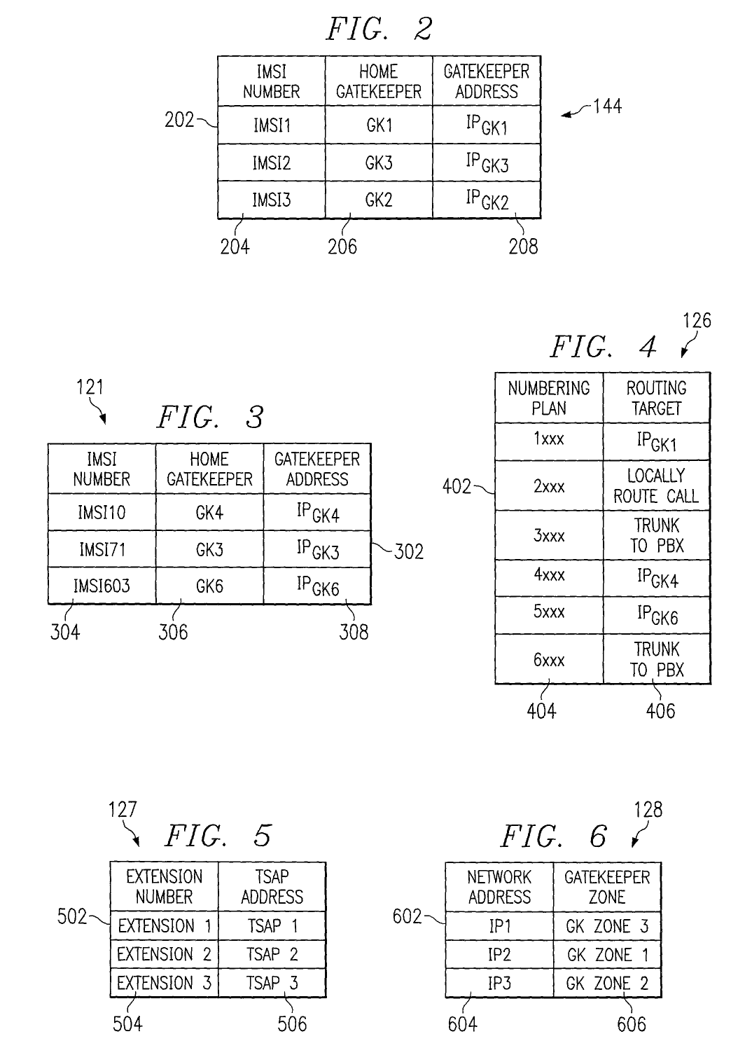

Home gatekeeper table 144 stores information identifying a home gatekeeper 112 for a mobile station 110. For example, home gatekeeper table 144 could include a mobile station identifier identifying a mobile station 110, a gatekeeper identifier identifying the home gatekeeper 112 of the mobile station 110, and a network address identifying the location of the home gatekeeper 112 in packet network 106. Other embodiments of home gatekeeper table 144 may be used without departing from the scope of the present invention. One example of home gatekeeper table 144 is shown in FIG. 2, which is described below.

In one embodiment, when a mobile station 110 registers with a WARP 114, WARP 114 communicates an inquiry message to integrated communications server 108. The inquiry message from WARP 114 may include an identification of mobile station 110. Integrated communications server 108 receives the inquiry message, access subscriber location register 142, and determines whether the mobile station 110 may receive service in system 100. Integrated communications server 108 may also access home gatekeeper table 144 and identify the home gatekeeper 112 of mobile station 110. Integrated communications server 108 may then communicate the identity of the home gatekeeper 112 to WARP 114. Integrated communications server 108 and WARP 114 may communicate using any suitable protocol. In one embodiment, WARP 114 and integrated communications server 108 communicate using a Mobility Management over Internet Protocol (MMIP) protocol, which facilitates the communication of mobility management information over packet network 106. Integrated communications server 108 may comprise any hardware, software, firmware, or combination thereof operable to communicate gatekeeper information to WARP 114. In the illustrated embodiment, integrated communications server 108 includes at least one processor 146 and at least one memory 148 operable to store data and instructions used by processor 146.

Although FIG. 1 illustrates one embodiment of system 100, various changes may be made to system 100 without departing from the scope of the present invention. For example, any number of base stations 116 may be coupled to each WARP 114, and any number of WARPs 114 may be coupled to packet network 106. Also, while WARPs 114 are illustrated as coupling base stations 116 and packet network 106, any other suitable wireless platform may be used to facilitate communication between base station 116 and packet network 106. Further, the various components of system 100 could be combined without departing from the scope of the present invention, and functions described as residing within one element of system 100 may be implemented in other elements of system 100. In addition, components of system 100 may perform the functions described above by executing steps to carry out the functions or by instructing other elements or components of system 100 to initiate performance of the functions. Beyond that, the functions in system 100 may be implemented in system 100 using any logic stored in at least one computer processable medium. The logic may be encoded in hardware, software instructions, and/or firmware instructions stored in any suitable device such as, for example, a random access memory (RAM), a read-only memory (ROM), an application-specific integrated circuit (ASIC), or a field programmable gate array (FPGA). Other changes may be made without departing from the scope of the present invention.

FIG. 2 is a block diagram illustrating an example home gatekeeper table 144 in integrated communications server 108 of communication system 100 of FIG. 1. Home gatekeeper table 144 may be useful, for example, for storing information identifying the home gatekeepers 112 of mobile stations 110. In the illustrated embodiment, table 144 includes one or more entries 202. Each entry 202 includes a mobile station identifier 204, a home gatekeeper identifier 206, and a gatekeeper address identifier 208. Other embodiments of table 144 may be used without departing from the scope of the present invention.

Mobile station identifiers 204 identify the mobile stations 110 that may communicate with and receive services from system 100. Mobile station identifier 204 may identify mobile station 110 using any suitable identifier. In the illustrated embodiment, mobile station identifier 204 comprises an International Mobile Subscriber Identify (IMSI) number. Other suitable identifiers may be used without departing from the scope of the present invention.

Home gatekeeper identifier 206 identifies a gatekeeper 112 that acts as a home gatekeeper for the mobile station 110 identified by mobile station identifier 204. Gatekeeper address identifier 208 identifies the network address of the home gatekeeper 112 identified by home gatekeeper identifier 206. In one embodiment, each gatekeeper 112 has an associated network address in packet network 106, and gatekeeper address identifier 208 identifies that network address. In the illustrated embodiment, each gatekeeper 112 has an associated Internet Protocol (IP) address in packet network 106, although other suitable addresses may be used without departing from the scope of the present invention.

In one embodiment, home gatekeeper table 144 in integrated communications server 108 may include an entry 202 for each mobile station 110 authorized to receive service in system 100. When mobile station 110 registers with a WARP 114 in system 100, integrated communications server 108 may access table 144 and identify the entry 202 corresponding to that mobile station 110. For example, integrated communications server 108 may receive an inquiry message from WARP 114, extract the IMSI number contained in the inquiry message, and identify the entry 202 having a matching IMSI number 204. Integrated communications server 108 may communicate the information contained in entry 202 to WARP 114.

FIG. 3 is a block diagram illustrating an example home gatekeeper table 121 in wireless platform 114 of communication system 110 of FIG. 1. Home gatekeeper table 121 may be useful, for example, for storing information identifying the home gatekeepers 112 of mobile stations 110 that are in the geographic area served by WARP 114. In the illustrated embodiment, table 121 includes one or more entries 302. Each entry 302 includes a mobile station identifier 304, a home gatekeeper identifier 306, and a gatekeeper address identifier 308. Other embodiments of table 121 may be used without departing from the scope of the present invention.

Mobile station identifier 304, home gatekeeper identifier 306, and gatekeeper address identifier 308 may be the same or similar to mobile station identifier 204, home gatekeeper identifier 206, and gatekeeper address identifier 208, respectively, from FIG. 2. In one embodiment, table 144 in integrated communications server 108 and table 121 in WARP 114 store information identifying the home gatekeepers 112 of mobile stations 110. In a particular embodiment, table 144 in integrated communications server 108 includes an entry 202 for each mobile station 110 authorized to receive service in system 100, while table 121 in WARP 114 includes an entry 302 for each mobile station 110 that is located in the geographic area served by WARP 114. When mobile station 110 enters the area covered by WARP 114, mobile station 110 communicates a location update message to WARP 114. WARP 114 communicates with integrated communications server 108, receives information identifying the home gatekeeper 112 of mobile station 110 and the address of the home gatekeeper 112, and stores that information as an entry 302 in table 121.

FIG. 4 is a block diagram illustrating an example number routing table 126 in gatekeeper 112 of communication system 100 of FIG. 1. Number routing table 126 may be useful, for example, in a gatekeeper 112 for storing information identifying a routing target associated with a numbering plan in system 100. In the illustrated embodiment, table 126 includes at least one entry 402. Each entry 402 includes a numbering plan identifier 404 and a routing target identifier 406. Other embodiments of number routing table 126 may be used without departing from the scope of the present invention.

Numbering plan identifiers 404 identify the different numbering plans that may be used in system 100. For example, a numbering plan could identify the extension numbers assigned to a group of mobile stations 110 in an office. Routing target identifier 406 identifies where a call setup message may be communicated when a telephone call is being directed at an extension number. For example, if the gatekeeper 112 using table 126 is the home gatekeeper 112 for a numbering plan, routing target identifier 406 may indicate that the call should be processed and/or routed locally. If voice traffic may be transported over packet network 106 to the gatekeeper 112 serving a numbering plan 404, routing target identifier 406 may identify the home gatekeeper 112 assigned to serve that numbering plan. If voice traffic may not be transported over packet network 106 to the gatekeeper 112 serving a numbering plan 404, routing target identifier 406 may identify a trunk or line over interface 138, and the call setup message may be routed to telephone subsystem 104. In a particular embodiment, routing target identifier 406 may be dynamically updated depending on the status of packet network 106. For example, table 400 could include both a network address of a gatekeeper 112 and a trunk or line over interface 138. In addition, table 400 could include a flag identifying which routing target to use. When gatekeeper 112 or another component of system 100 checks if packet network 106 may support voice traffic, gatekeeper 112 could update the flags in table 400 based on the results of the test.

When a gatekeeper 112 receives a call setup message, gatekeeper 112 may extract the telephone number of the destination from the setup message. Gatekeeper 112 may access number routing table 126 to determine where to route the setup message. If table 126 indicates that the call is to be processed locally, gatekeeper 112 may use extension number table 127, call routing table 128, and/or gatekeeper zone table 129 to identify a target for the call setup message. Otherwise, gatekeeper 112 may route the setup message to the target identified by table 126.

FIG. 5 is a block diagram illustrating an example extension number table 127 in gatekeeper 112 of communication system 100 of FIG. 1. Extension number table 127 may be useful, for example, in a gatekeeper 112 for storing information identifying the WARP 114 currently serving a registered mobile station 110. In the illustrated embodiment, table 127 includes at least one entry 502. Each entry 502 includes an extension number identifier 504 and a TSAP identifier 506. Other embodiments of extension number table 127 may be used without departing from the scope of the present invention.

Extension number identifiers 504 identify the extension numbers assigned to mobile stations 110 served by this gatekeeper 112. For example, a gatekeeper 112 could be assigned to act as the home gatekeeper 112 for mobile stations 110 having extensions numbers of “3xxx,” and extension number identifiers 504 may identify one or more of these extension numbers. TSAP identifier 506 identifies the TSAP address of a WARP 114 serving the mobile station 110 that has the extension number identified by extension number identifier 504. In one embodiment, TSAP identifier 506 identifies the network address of the WARP 114 and a port number of WARP 114 that is associated with mobile station 110. In a particular embodiment, TSAP identifier 506 identifies the IP address of the WARP 114 and a Transmission Control Protocol (TCP) port number of WARP 114 that is associated with mobile station 110. Other identifiers may be used to identify a WARP 114 serving a mobile station 110 without departing from the scope of the present invention.

When a gatekeeper 112 receives a call setup message, gatekeeper 112 may extract the telephone number of the destination from the setup message. Gatekeeper 112 may access number routing table 126 to determine where to route the setup message. If table 126 indicates that the call is to be processed locally, gatekeeper 112 may access extension number table 127 to identify a TSAP address for a WARP 114 that may be serving the destination mobile station 110. If the extension number of the mobile station 110 does not have an associated TSAP address in table 127, the destination mobile station 110 may not be registered with gatekeeper 112. In that case, gatekeeper 112 may route the call to telephone subsystem 104 for delivery to a telephone 130 or to a voice mail device associated with mobile station 110. Otherwise, gatekeeper 112 may use call routing table 128 and/or gatekeeper zone table 129 to identify whether the call setup message should be routed to a WARP 114 in this gatekeeper zone 102, an agent gatekeeper 112 serving another gatekeeper zone 102, or telephone subsystem 104.

FIG. 6 is a block diagram illustrating an example call routing table 128 in gatekeeper 112 of communication system 100 of FIG. 1. Call routing table 128 may be useful, for example, in a gatekeeper 112 for storing information identifying the gatekeeper zone 102 associated with the network address of a WARP 114 serving a registered mobile station 110. In the illustrated embodiment, table 128 includes at least one entry 602. Each entry 602 includes a network address identifier 604 and a gatekeeper zone identifier 606. Other embodiments of call routing table 128 may be used without departing from the scope of the present invention.

Network address identifier 604 identifies a network address of a WARP 114 serving a mobile station 110. In the illustrated embodiment, each WARP 114 has an associated IP address, although other suitable addresses may be used without departing from the scope of the present invention. Gatekeeper 112 may identify a network address of a WARP 114 by extracting the address from a TSAP address stored in table 127. Gatekeeper zone identifier 606 identifies the gatekeeper zone 102 in which the WARP 114 identified by the network address is located. For example, a network address identified by identifier 604 may represent WARP 114c, which resides in the third gatekeeper zone 102c. A network address in another entry 602 may represent a WARP 114 in another gatekeeper zone 102.

Gatekeeper 112 may receive a call setup message, use table 126 to determine that the call may be processed locally, and use table 127 to identify a TSAP address associated with the destination mobile station 110. Gatekeeper 112 may then extract the network address contained in the TSAP address from table 127, access table 128, and identify the gatekeeper zone 102 associated with that network address. Using this information, gatekeeper 112 may determine whether the destination mobile station 110 is roaming. For example, gatekeeper 112 may compare the identified gatekeeper zone 102 with the zone 102 in which gatekeeper 112 is located. If the zones 102 are the same, the destination mobile station 110 is not roaming, and gatekeeper 112 may route the call setup message to the WARP 114 serving mobile station 110 using the TSAP address from table 127. Otherwise, mobile station 110 is roaming in an agent gatekeeper zone 102. Gatekeeper 112 may use gatekeeper zone table 129 to identify whether the call setup message should be routed to the agent gatekeeper 112 serving another gatekeeper zone 102 or telephone subsystem 104.

FIG. 7 is a block diagram illustrating an example gatekeeper zone table 129 in gatekeeper 112 of communication system 100 of FIG. 1. Gatekeeper zone table 129 may be useful, for example, in a gatekeeper 112 for storing information identifying the network address of each gatekeeper 112 in system 100 and the network addresses of the WARPs 114 served by those gatekeepers 112. In the illustrated embodiment, table 129 includes at least one entry 702. Each entry 702 includes a gatekeeper zone identifier 606, a gatekeeper address identifier 704, and at least one WARP address identifier 706. Other embodiments of gatekeeper zone table 129 may be used without departing from the scope of the present invention.

Gatekeeper zone identifiers 606 identify the different gatekeeper zones 102 in system 100. Gatekeeper address identifier 704 identifies the network address of the gatekeeper 112 serving the gatekeeper zone 102 identified by the gatekeeper zone identifiers 606. In the illustrated embodiment, each gatekeeper 112 has an associated IP address, although other suitable addresses may be used without departing from the scope of the present invention. WARP address identifiers 706 identify the network addresses of the WARP 114 or WARPs 114 in the gatekeeper zone 102 identified by the gatekeeper zone identifiers 606. In the illustrated embodiment, each WARP 114 has an associated IP address, although other suitable addresses may be used without departing from the scope of the present invention.

When gatekeeper 112 has received a call setup message, identified a TSAP address associated with the destination mobile station 110, and identified the gatekeeper zone 102 associated with the TSAP address, gatekeeper 112 determines if mobile station 110 is roaming. If the destination mobile station 110 is roaming, gatekeeper 112 uses the gatekeeper zone 102 identified using table 128 to access gatekeeper zone table 129. Gatekeeper 112 identifies the network address of the agent gatekeeper 112 serving the zone 102 identified using table 128. If voice traffic may be routed over packet network 106, gatekeeper 112 may communicate a call setup message to the agent gatekeeper 112 using the gatekeeper address from table 129. If voice traffic may not be routed over packet network 106, gatekeeper 112 may have previously received a call forwarding activation message to the roaming number assigned to the destination mobile station 110. Gatekeeper 112 triggers a call forward to the roaming number and communicates a call setup message to telephone subsystem 104, which routes a setup message to the agent gatekeeper 112 associated with the roaming number.

In this way, tables 126-129 may be used to route a call setup message to a WARP 114 serving a destination mobile station 110, telephone subsystem 104, or another gatekeeper 112 in system 100. This helps gatekeepers 112 to route calls in system 100 when a calling mobile station 110, a destination mobile station 110, or both are roaming in system 100.

Table 129 may have other uses in system 100. For example, when voice traffic may not be routed over packet network 106, a mobile station 110 may initiate a telephone call. The WARP 114 serving the calling mobile station 110 communicates a setup message to the home gatekeeper 112 of mobile station 110. The home gatekeeper 112 may extract the network address of the WARP 114 communicating the message, access table 129, and identify the gatekeeper zone 102 in which mobile station 110 is located. Using this information, home gatekeeper 112 may determine if mobile station 110 is roaming. If mobile station 110 is roaming, home gatekeeper 112 may communicate the setup message to the agent gatekeeper 112 serving the zone 102 in which mobile station 110 is located. This allows the agent gatekeeper 112 to establish a call through telephone subsystem 104, rather than over packet network 106.

Although FIGS. 2-7 illustrates example tables used in system 100, various changes may be made to the tables without departing from the scope of the present invention. For example, while the information in FIGS. 2-7 is illustrated as being stored in tables, any other suitable data structures, compilations, or arrangements may be used to store the information contained in those tables.

FIG. 8 is a block diagram illustrating an example set of signaling and bearer messages in communication system 100 of FIG. 1. In particular, FIG. 8 illustrates the signaling and bearer messages used when a roaming mobile station 110a initiates a call to a non-roaming mobile station 110b, where mobile stations 110a and 110b have different home gatekeepers 112a and 112c. In this example, voice traffic may be routed over packet network 106.

Mobile station 110a initiates the call using message 802, which travels to WARP 114b overwireless interface 118 and abase station 116. The message 802 may, for example, identify the destination of the telephone call, which is mobile station 110b. The message 802 may use any suitable protocol, such as a GSM protocol. WARP 114b receives the message 802 and identifies the mobile station 110a initiating the message 802. WARP 114b may have previously communicated an inquiry message to integrated communications server 108, and integrated communications server 108 replied with a message identifying the home gatekeeper 112a of mobile station 110a. WARP 114b accesses home gatekeeper table 121, identified the home gatekeeper 112a of mobile station 110a, and communicates a call setup message 804 to the home gatekeeper 112a. This may include, for example, WARP 114b generating an H.323 message and communicating the message to gatekeeper 112a. In a particular embodiment, the call setup message comprises an ITU-T H.225 message.

Gatekeeper 112a receives the message 804 and accesses number routing table 126. Because voice traffic may be routed over packet network 106, number routing table 126 identifies a network address of the home gatekeeper 112c of the destination mobile station 10b. As a result, gatekeeper 112a communicates a call setup message 806 to gatekeeper 112c. Gatekeeper 112c receives message 806, accesses number routing table 126, and determines that the call may be processed locally. Gatekeeper 112c uses extension number table 127 to identify the TSAP address of the WARP 114c serving mobile station 110b, and gatekeeper 112c uses call routing table 128 to identify the gatekeeper zone 102 in which WARP 114c is located. Gatekeeper 112c determines that mobile station 110b is not roaming. Gatekeeper 112c uses the identified TSAP address of WARP 114c from table 127 and communicates a call setup message 808 to WARP 114c. WARP 114c then initiates a page 810 for mobile station 110b.

If the subscriber answers the telephone call at mobile station 110b, a bearer channel 812 is established between mobile station 110b and WARP 114a over wireless interface 118. A bearer channel is a path in system 100 that may transport voice traffic between two components of system 100. The bearer channel 812 may be used, for example, to transport voice information over a GSM circuit between WARP 114a and mobile station 110b. A logical channel 814 is established between WARP 114c and WARP 114b. The logical channel 814 may be used, for example, to transport voice information over packet network 106. WARP 114b establishes a bearer channel 816 between WARP 114b and mobile station 110a. WARP 114c bridges bearer channel 812 and logical channel 814, allowing mobile station 110b to communicate information over packet network 106. Bridging the logical channel and the bearer channel facilitates the communication of voice information between the logical channel and bearer channel. For example, WARP 114c may receive voice information over the bearer channel, packetize the information, and communicate the information over packet network 106 using the logical channel. WARP 114c may also receive packetized information over the logical channel, depacketize the information, and communicate the information over the bearer channel. WARP 114b bridges logical channel 814 and bearer channel 816, allowing mobile station 110a to communicate information over packet network 106. This allows mobile station 110a and mobile station 110b to communicate.

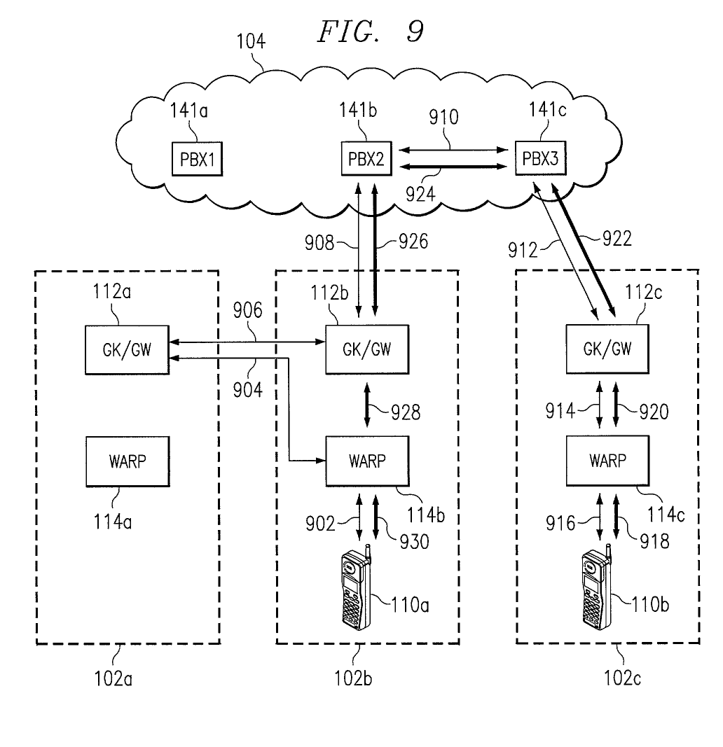

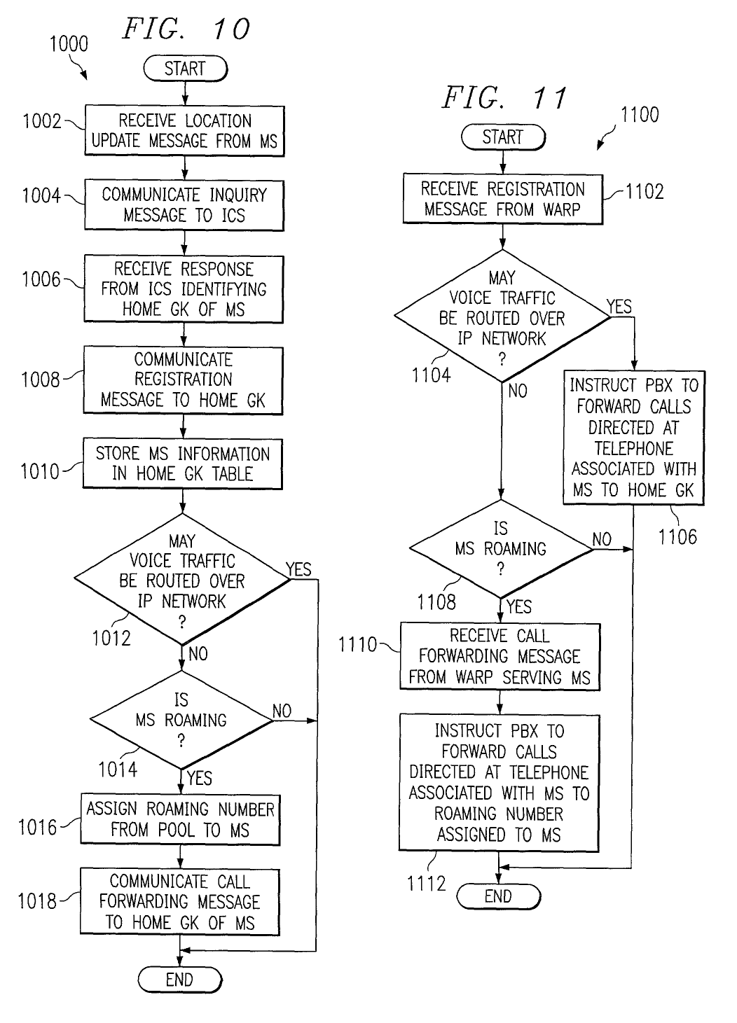

FIG. 9 is a block diagram illustrating another example set of signaling and bearer messages in communication system 100 of FIG. 1. In particular, FIG. 9 illustrates the signaling and bearer messages used when a roaming mobile station 110a initiates a call to a non-roaming mobile station 10b, where mobile stations 110a and 110b have different home gatekeepers 112a and 112c. Voice traffic may not be routed over packet network 106.

When mobile station 110a initiates the telephone call, mobile station 110a communicates a message 902 to WARP 114b. WARP 114b accesses table 121, identifies the home gatekeeper 112a of mobile station 110a, and communicates a call setup message 904 to the home gatekeeper 112a.

Gatekeeper 112a receives the setup message 904 and determines whether mobile station 110a is roaming. Gatekeeper 112a may, for example, extract the network address of WARP 114b from message 904, access gatekeeper zone table 129, and determine that the address of WARP 114b serves an agent gatekeeper zone 102b. Because mobile station 110a is roaming in agent gatekeeper zone 102b, gatekeeper 110a communicates a call setup message 906 to the agent gatekeeper 112b serving zone 102b. This allows gatekeeper 112b to set up a connection with the destination through telephone subsystem 104.

Gatekeeper 112b receives setup message 906 and accesses number routing table 126. Because voice traffic may not be routed over packet network 106, number routing table 126 indicates that a setup message may be communicated to the home gatekeeper 112c of the destination mobile station 110b through PBX 141b. Gatekeeper 112b begins establishing a communication path through telephone subsystem 104 by communicating a setup message 908 to PBX 141b. PBX 141b communicates a setup message 910 to PBX 141c, and PBX 141c communicates a setup message 912 to the home gatekeeper 112c of the destination. Gatekeeper 112c uses tables 127-128 to determine that the destination of the call is a registered non-roaming mobile station 110b. Gatekeeper 112c communicates a setup message 914 to the WARP 114c serving mobile station 110b. WARP 114c initiates a page 916 of mobile station 110b, completing the signaling path between mobile stations 110a and 110b.

If a subscriber answers the call at mobile station 110b, a bearer channel 918 is established between mobile station 110b and WARP 114c, and a logical channel 920 is established between WARP 114c and gatekeeper 112c. A bearer channel 922 is established between gatekeeper 112c and PBX 141c, a bearer channel 924 is established between PBX 141c and PBX 141b, and a bearer channel 926 is established between PBX 141b and gatekeeper 112b. This facilitates the transport of voice information through telephone subsystem 104. A logical channel 928 is established between WARP 114b and gatekeeper 112b, which facilitates the transport voice information over packet network 106. A bearer channel 930 is established between WARP 114b and mobile station 110a, completing the bearer path between mobile stations 110a and 110b through telephone subsystem 104. Mobile stations 110a and 110b may communicate and exchange voice information.

Although FIG. 9 illustrates one example of the signaling and bearer messages used to establish a telephone call between a roaming mobile station 110a and a non-roaming mobile station 110b, various changes may be made to FIG. 9 without departing from the scope of the present invention. For example, in the illustrated embodiment, gatekeepers 112b and 112c include the functionality of a gateway 140. If gatekeepers 112b and 112c and gateways 140 are separate components, call setup messages may be routed from a gatekeeper 112 to a PBX 141 through a gateway 140. Also, logical channel 920 would be established between a first gateway 140 and WARP 114c, bearer channel 922 would be established between PBX 141c and the first gateway 140, bearer channel 926 would be established between PBX 141b and a second gateway 140, and logical channel 928 would be established between the second gateway 140 and WARP 114b.

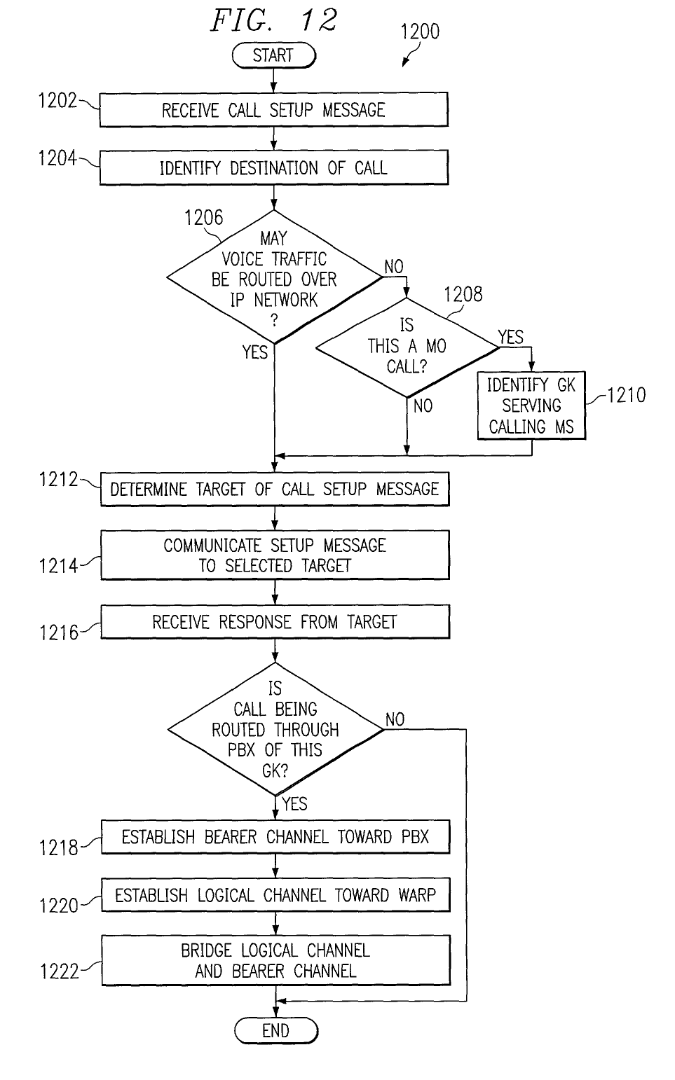

FIG. 10 is a flow diagram illustrating an example method 1000 for location updating. Method 1000 may be useful, for example, in a WARP 114 when a mobile station 110 roams into the geographic area served by WARP 114. WARP 114 receives a location update message from a mobile station 110 at step 1002. This may include, for example, WARP 114 receiving a GSM location update message from mobile station 110 through base station 116. WARP 114 communicates an inquiry message to integrated communications server 108 at step 1004. This may include, for example, WARP 114 generating an MMIP message identifying the mobile station 110 and communicating the message to integrated communications server 108. WARP 114 receives a response from the integrated communications server 108 identifying a home gatekeeper 112 of mobile station 110 at step 1006. This may include, for example, WARP 114 receiving an MMIP message from integrated communications server 108 identifying the home gatekeeper 112 of mobile station 110.

Once WARP 114 knows the identity of home gatekeeper 112, WARP 114 communicates a registration message to home gatekeeper 112 at step 1008. This may include, for example, WARP 114 generating and communicating an H.323 registration message to home gatekeeper 112. WARP 114 stores the information associated with mobile station 110 in home gatekeeper table 121 at step 1010. This may include, for example, WARP 114 storing the IMSI number associated with mobile station 110, the identity of the home gatekeeper 112 associated with mobile station 110, and the network address of the home gatekeeper 112.

WARP 114 determines if voice traffic may be communicated over packet network 106 at step 1012. This may include, for example, WARP 114 examining a flag that indicates the status of packet network 106. If packet network 106 may transport voice traffic, method 1000 ends. WARP 114 need take no further action to register a mobile station 110. Otherwise, WARP 114 determines if mobile station 110 is roaming at step 1014. This may include, for example, WARP 114 comparing the identity of the home gatekeeper 112 of mobile station 110 with the gatekeeper 112 serving the zone 102 in which WARP 114 is located. If mobile station 110 is not roaming, method 1000 ends. WARP 114 need take no further steps to register mobile station 110. Otherwise, mobile station 110 is roaming, and WARP 114 assigns a roaming number to mobile station 110 at step 1016. WARP 114 communicates a call forwarding activation message to the home gatekeeper 112 of mobile station 110 at step 1018. This may include, for example, WARP 114 communicating an H.450.3 message to the home gatekeeper 112. The H.450.3 message may include the roaming number assigned to mobile station 110 by WARP 114.

Although FIG. 10 illustrates one example method 1000 for location updating, various changes may be made to method 1000 without departing from the scope of the present invention. For example, if a complete home gatekeeper table 144 is maintained in each WARP 114, WARP 114 would not need to communicate with integrated communications server 108 to identify the home gatekeeper 112 of a mobile station 110. Also, WARP 114 may store the information in home gatekeeper table 121 before communicating a registration message to the home gatekeeper 112. In addition, WARP 114 may be customized for system 100 such that WARP 114 need not perform step 1012. For example, if voice traffic may be transported over packet network 106, WARP 114 could perform steps 1002-1010. If voice traffic may not be transported over packet network 106, WARP 114 could perform steps 1002-1010 and steps 1014-1018.

FIG. 11 is a flow diagram illustrating another example method 1100 for location updating. Method 1100 may be useful, for example, in a gatekeeper 112 when a mobile station 110 roams into different geographic areas in system 100. Gatekeeper 112 receives a registration message from a WARP 114 serving a mobile station 110 at step 1102. This may include, for example, gatekeeper 112 receiving an H.323 message from WARP 114 over packet network 106. The registration message may include information identifying the mobile station 110 registering with gatekeeper 112. Gatekeeper 112 determines if voice traffic may be routed over packet network 106 at step 1104. If so, gatekeeper 112 instructs PBX 141 to forward calls directed at a telephone 130 associated with mobile station 110 to the gatekeeper 112 at step 1106. This may include, for example, gatekeeper 112 activating a call forwarding unconditional (CFU) feature in PBX 141 using CTI interface 136. If PBX 141 receives a telephone call directed at telephone 130 associated with mobile station 110 while mobile station 110 is registered with gatekeeper 112, PBX 141 will forward the call to gatekeeper 112. Gatekeeper 112 may then route the call to the appropriate location in system 100, helping to ensure that mobile station 110 may receive the forwarded calls even when roaming in system 100.

If voice traffic may not be routed over packet network 106, gatekeeper 112 determines whether the mobile station 110 is roaming at step 1108. This may include, for example, gatekeeper 112 using table 129. If the mobile station 110 is not roaming, gatekeeper 112 may instruct PBX 141 to forward calls to gatekeeper 112 at step 1106. Otherwise, mobile station 110 is roaming. Gatekeeper 112 may receive a call forwarding activation message from WARP 114 serving mobile station 110 at step 1110. The message may identify the roaming number assigned to the mobile station 110 in the agent zone 102. Gatekeeper 112 may then instruct PBX 141 to forward calls directed at a telephone 130 associated with mobile station 110 to the roaming number of mobile station 110 at step 1112. If PBX 141 receives a telephone call directed at telephone 130 while mobile station 110 is roaming, PBX 141 will forward the call to the roaming number. The agent gatekeeper 112 serving the zone 102 in which mobile station 110 is roaming may receive the message and route the call to the appropriate location in system 100. Gatekeeper 112 may also activate its own call forwarding feature in response to the call forwarding activation message. If gatekeeper 112 receives a call for the roaming mobile station 110, gatekeeper 112 may trigger a call forward and communicate a setup message to the agent gatekeeper 112 serving mobile station 110 through telephone subsystem 104.

Although FIG. 11 illustrates one example method 1100 for location updating, various changes may be made to method 1100 without departing from the scope of the present invention. For example, gatekeeper 112 may be customized for system 100 such that gatekeeper 112 need not perform step 1104. For example, if voice traffic may be transported over packet network 106, gatekeeper 112 could perform steps 1102 and 1106. If voice traffic may not be transported over packet network 106, gatekeeper 112 could perform steps 1102 and 1108-1112.

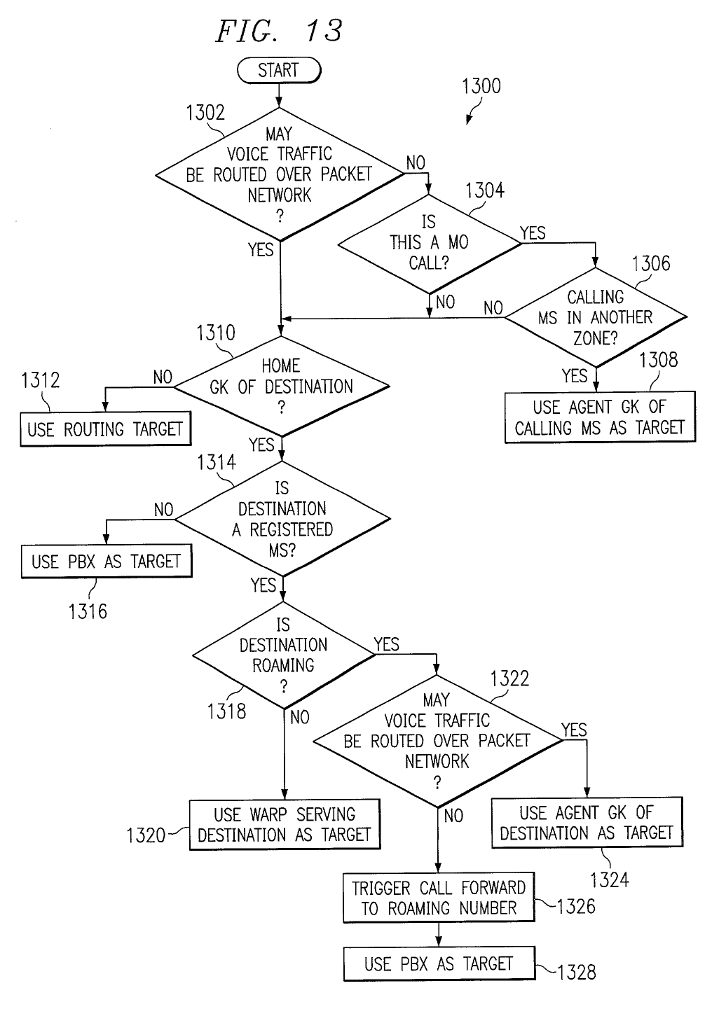

FIG. 12 is a flow diagram illustrating an example method 1200 for performing a call setup in communication system 100. Method 1200 may, for example, be used by the gatekeepers 112 in system 100 to control the routing of telephone calls in system 100.

Gatekeeper 112 receives a call setup message at step 1202. The call setup message may represent a telephone call originating at mobile station 110 or directed at mobile station 110. Gatekeeper 112 identifies the destination of the telephone call at step 1204. This may include, for example, gatekeeper 112 extracting the destination of the call from the setup message received during step 1202. Gatekeeper 112 determines whether voice traffic may be routed over packet network 106 at step 1206. If not, gatekeeper 112 determines whether the call setup message represents a mobile-originated call at step 1208. A mobile-originated call represents a telephone call initiated by a mobile station 110. In one embodiment, the setup message for a mobile-originated call may be preceded by an Admissions Request (ARQ) message, and gatekeeper 112 may use the presence or absence of an ARQ message to determine if a call is a mobile-originated call. If the call is mobile-originated, gatekeeper 112 identifies the gatekeeper 112 serving the zone in which the calling mobile station 110 is located at step 1210. This may include, for example, gatekeeper 112 extracting the network address of the WARP 114 that sent the setup message, accessing table 129, and identifying the gatekeeper zone 102 of the WARP 114.

Gatekeeper 112 determines the routing target for the call setup message at step 1212. One example of a method for determining a routing target for a setup message is illustrated in FIG. 15, which is described below. This may include, for example, gatekeeper 112 using one or more of tables 126-129 to select a target for the setup message. Once gatekeeper 112 selects a target for the setup message, gatekeeper 112 communicates the setup message to the selected target at step 1214. This may include, for example, gatekeeper 112 communicating the setup message to PBX 141, WARP 114, or another gatekeeper 112 in system 100. Gatekeeper 112 receives a response from the selected target at step 1216. This may include, for example, gatekeeper 112 receiving an alerting message indicating that the destination of the telephone call is ringing and/or a connect message indicating that the telephone call has been answered at the destination.

Gatekeeper 112 may perform additional steps if the telephone call is being routed through the PBX 141 coupled to the gatekeeper 112 and gatekeeper 112 includes the functionality of a gateway 140. If the call is being routed through PBX 141, gatekeeper 112 establishes a bearer channel toward PBX 141 at step 1218. This may include, for example, gatekeeper 112 establishing a bearer channel toward PBX 141 or instructing a gateway 140 to establish a bearer channel toward PBX 141. In a particular embodiment, the bearer channel comprises a GSM bearer channel. Gatekeeper 112 also establishes a logical channel toward a WARP 114 at step 1220. The WARP 114 may, for example, be serving a calling mobile station 110 that initiated the call or a mobile station 110 that is the destination of the call. Gatekeeper 112 may establish the logical channel using a TSAP address of the WARP 114 serving the mobile station 110. The logical channel facilitates the communication of voice information between gatekeeper 112 and WARP 114 over packet network 106. Gatekeeper 112 bridges the logical channel and bearer channel at step 1222. This may include, for example, gatekeeper 112 bridging the logical channel and bearer channel, or gatekeeper 112 instructing gateway 140 to bridge the logical channel and the bearer channel.

Although FIG. 12 illustrates one example method 1200 for performing a call setup in system 100, various changes may be made to method 1200 without departing from the scope of the present invention. For example, gatekeeper 112 may be customized for system 100 such that gatekeeper 112 need not perform step 1206. For example, if voice traffic may be transported over packet network 106, gatekeeper 112 could perform steps 1202-1204 and 1212-1222. If voice traffic may not be transported over packet network 106, gatekeeper 112 could perform steps 1202-1204 and 1208-1222.

FIG. 13 is a flow diagram illustrating an example method 1300 for determining a target for a call setup message in communication system 100. Method 1300 may, for example, be used by the gatekeepers 112 in system 100 to determine where to route a call setup message in system 100. Gatekeeper 112 determines whether voice traffic may be communicated over packet network 106 at step 1302. If it cannot, gatekeeper 112 determines if the setup message represents a mobile-originated call at step 1304. This may include, for example, determining if the setup message was preceded by an ARQ message. If the call is a mobile-originated call, gatekeeper 112 determines if the calling mobile station 110 is in another gatekeeper zone 102 at step 1306. This may include, for example, gatekeeper 112 using the network address of the WARP 114 that communicated the message and gatekeeper zone table 129. If the calling mobile station 110 is roaming in another zone 102, gatekeeper 112 selects the agent gatekeeper 112 serving the zone 102 in which the calling mobile station 110 is located as the routing target at step 1308. Because voice traffic may not be communicated over packet network 106, the call from the calling mobile station 110 may be routed through telephone subsystem 104. The agent gatekeeper 112 serving the calling mobile station 110 therefore receives the message so that it can decide whether to route the call through the telephone subsystem 104.

If voice traffic may be transported over packet network 106, the setup message does not represent a mobile-originated call, or the calling mobile station 110 is not roaming, gatekeeper 112 determines whether it is the home gatekeeper 112 of the destination at step 1310. This may include, for example, gatekeeper 112 extracting the destination from the setup message and accessing number routing table 126. If gatekeeper 112 is not the home gatekeeper of the destination, number routing table 126 may identify a routing target for the setup message. The target may be a network address of another gatekeeper 112 or a trunk or line over interface 138 to telephone subsystem 104. In that case, gatekeeper 112 uses the routing target identified in number routing table 126 at step 1312.

If gatekeeper 112 is the home gatekeeper of the destination, number routing table 126 may indicate that the setup message may be processed and/or routed locally. Gatekeeper 112 then determines whether the destination is a registered mobile station 110 at step 1314. This may include, for example, gatekeeper 112 using extension number table 127 to determine if a TSAP address is associated with the extension number of the destination mobile station 110. If there is no TSAP address associated with the extension number of the destination mobile station 110, the destination mobile station 110 is not registered. Gatekeeper 112 selects the PBX 141 associated with gatekeeper 112 as the routing target at step 1316. In this case, the call setup message may be directed at a telephone 130 associated with mobile station 110.

If the destination is a registered mobile station 110, gatekeeper 112 determines whether the mobile station 110 is currently roaming at step 1212. This may include, for example, gatekeeper 112 accessing call routing table 128 and determining whether the TSAP address associated with mobile station 110 is in another gatekeeper zone 102. If the destination mobile station 110 is not roaming, gatekeeper 112 selects the WARP 114 serving the destination mobile station 110 as the routing target at step 1320. In this case, the mobile station 110 is currently in this gatekeeper zone 102, and the gatekeeper 112 may route the setup message to the WARP 114 is this zone 102 using its TSAP address.

If the destination mobile station 110 is roaming, gatekeeper 112 determines whether voice traffic may be routed over packet network 106 at step 1322. If it can, gatekeeper 112 selects the agent gatekeeper 112 serving the gatekeeper zone 102 in which the destination mobile station 110 is located at step 1324. Otherwise, gatekeeper 112 may have previously received a call forwarding activation message from the WARP 114 serving the destination mobile station 110. The call forwarding activation message includes the roaming number assigned to the destination mobile station 110 by WARP 114. Gatekeeper 112 triggers a call forward to the roaming number at step 1326, and gatekeeper 112 selects the telephone subsystem 104 as the routing target at step 1328. The call forwarding activation message causes gatekeeper 112 to communicate a setup message to the telephone subsystem 104, and the telephone subsystem 104 may route the setup message to the agent gatekeeper 112 associated with the roaming number.

Using method 1300, each gatekeeper 112 may route call setup messages to the appropriate component of system 100. Gatekeeper 112 may select the appropriate routing target for a setup message, even when a calling mobile station 110 and/or a destination mobile station 110 are roaming in system 100. Also, by routing the setup messages initially through the home gatekeeper 112 associated with the calling mobile station 110 and then through the home gatekeeper 112 of the destination where appropriate, system 100 helps to ensure that the gatekeepers 112 may provide the same services to their mobile stations 110 even when the mobile stations 110 are roaming in system 100.

Although FIG. 13 illustrates one example embodiment of a method 1300 for identifying a routing target for a setup message in communication system 100, various changes may be made to method 1300 without departing from the scope of the present invention. For example, gatekeeper 112 may be customized for system 100 such that gatekeeper 112 need not check whether voice traffic may be routed over packet network 106. As particular examples, if packet network 106 may transport voice traffic, gatekeeper 112 need not perform steps 1302-1308 and 1326-1328. Similarly, if packet network 106 may not transport voice traffic, gatekeeper 112 could proceed directly to step 1304 when method 1300 starts. Gatekeeper 112 could also proceed directly to step 1326 from step 1318, skipping step 1322.

Although the present invention has been described with several embodiments, a number of changes, substitutions, variations, alterations, and modifications may be suggested to one skilled in the art, and it is intended that the invention encompass all such changes, substitutions, variations, alterations, and modifications that fall within the spirit and scope of the appended claims.

What is claimed is:

1. A method for gatekeeper networking, comprising:
receiving a registration message from a wireless platform serving a mobile station at a home gatekeeper of the mobile station;
instructing a telephone subsystem to forward a call directed at a telephonic device associated with the mobile station to one of the home gatekeeper of the mobile station and a roaming number assigned to the mobile station;
receiving a call setup message at the home gatekeeper of the mobile station, the call setup message representing a call involving the mobile station;
identifying a destination of the call using the call setup message;
identifying a routing target associated with the destination; and
communicating the call setup message to the routing target when the home gatekeeper of the mobile station is not a home gatekeeper of the destination.

2. The method of claim 1, wherein the routing target comprises one of a network address of the home gatekeeper of the destination and an interface to the telephone subsystem.

3. The method of claim 1, further comprising:
determining if the destination is a registered mobile station when the home gatekeeper of the mobile station is the home gatekeeper of the destination; and
communicating the call setup message to the telephone subsystem through a gateway when the destination is not a registered mobile station.

4 The method of claim 3, further comprising:
determining if the destination is roaming in an agent gatekeeper zone when the destination is a registered mobile station; and
communicating the call setup message to a wireless platform serving the destination when the destination is not roaming.

5. The method of claim 4, further comprising communicating the call setup message to an agent gatekeeper serving the agent gatekeeper zone when the destination is roaming.

6. The method of claim 4, further comprising:
triggering a call forward to a roaming number assigned to the destination when the destination is roaming; and
communicating the call setup message to the telephone subsystem through a gateway.

7. The method of claim 6, wherein the mobile station is the destination of the call.

8. The method of claim 1, further comprising:
determining if the call setup message represents a mobile-originated call from the mobile station;
determining if the mobile station is roaming in an agent gatekeeper zone; and
communicating the call setup message to an agent gatekeeper serving the agent gatekeeper zone when the call setup message represents a mobile-originated call and the mobile station is roaming.

9. The method of claim 1, wherein instructing the telephone subsystem to forward the call directed at the telephonic device comprises activating a call forwarding feature in the telephone subsystem using a Computer Telephony Integration (CTI) interface.

10. The method of claim 9, wherein:
the home gatekeeper of the mobile station may communicate voice bearer traffic over a packet network; and
instructing the telephone subsystem to forward the call comprises instructing the telephone subsystem to forward the call to the home gatekeeper of the mobile station.

11. The method of claim 9, wherein:
the home gatekeeper of the mobile station may not communicate voice bearer traffic over a packet network;
the mobile station is roaming in an agent gatekeeper zone; and
instructing the telephone subsystem to forward the call comprises instructing the telephone subsystem to forward the call to the roaming number assigned to the mobile station.

12. The method of claim 1, further comprising receiving a call forwarding activation message from the wireless platform when the mobile station is roaming in an agent gatekeeper zone, the call forwarding activation message identifying the roaming number assigned to the mobile station.

13. The method of claim 12, wherein the call forwarding activation message comprises an International Telecommunications Union-Telecommunications (ITU-T) H.450.3 message.

14. The method of claim 1, wherein identifying the routing target associated with the destination comprises accessing a table associating at least one numbering plan with a routing target.

15. The method of claim 14, wherein the table comprises one of a plurality of tables; and
further comprising selecting one of the tables based on whether the home gatekeeper of the mobile station may communicate voice bearer traffic over a packet network

16. The method of claim 1, wherein the wireless platform is associated with a gatekeeper zone served by a gatekeeper other than the home gatekeeper of the mobile station.

17. The method of claim 1, wherein the call involving the mobile station originates in the telephone subsystem.

18. The method of claim 1, wherein the registration message comprises an International Telecommunications Union-Telecommunications (ITU-T) H.323 message.

19. The method of claim 1, wherein the call setup message comprises an International Telecommunications Union-Telecommunications (ITU-T) H.225 message.

20. The method of claim 1, further comprising:
establishing a bearer channel toward the telephone subsystem;
establishing a logical channel toward the wireless platform; and
bridging the bearer channel and the logical channel.

21. A system for gatekeeper networking, comprising:
at least one computer processable medium; and
logic encoded on the at least one computer processable medium and operable to:
receive a registration message from a wireless platform serving a mobile station at a home gatekeeper of the mobile station;
instruct a telephone subsystem to forward a call directed at a telephonic device associated with the mobile station to one of the home gatekeeper of the mobile station and a roaming number assigned to the mobile station;
receive a call setup message at the home gatekeeper of the mobile station, the call setup message representing a call involving the mobile station;
identify a destination of the call using the call setup message;
identify a routing target associated with the destination; and
communicate the call setup message to the routing target when the home gatekeeper of the mobile station is not a home gatekeeper of the destination.

22. The system of claim 21, wherein the routing target comprises one of a network address of the home gatekeeper of the destination and an interface to the telephone subsystem.

23. The system of claim 21, wherein the logic is further operable to:
determine if the destination is a registered mobile station when the home gatekeeper of the mobile station is the home gatekeeper of the destination;
communicate the call setup message to the telephone subsystem through a gateway when the destination is not a registered mobile station;
determine if the destination is roaming in an agent gatekeeper zone when the destination is a registered mobile station; and
communicate the call setup message to a wireless platform serving the destination when the destination is not roaming.

24. The system of claim 23, wherein the logic is further operable to communicate the call setup message to an agent gatekeeper serving the agent gatekeeper zone when the destination is roaming.

25. The system of claim 23, wherein the logic is further operable to:
trigger a call forward to a roaming number assigned to the destination when the destination is roaming; and
communicate the call setup message to the telephone subsystem through a gateway.

26. The system of claim 21, wherein the logic is further operable to:
determine if the call setup message represents a mobile-originated call from the mobile station;
determine if the mobile station is roaming in an agent gatekeeper zone; and
communicate the call setup message to an agent gatekeeper serving the agent gatekeeper zone when the call setup message represents a mobile-originated call and the mobile station is roaming.

27. The system of claim 21, wherein the logic is operable to instruct the telephone subsystem to forward the call directed at the telephonic device by activating a call forwarding feature in the telephone subsystem using a Computer Telephony Integration (CTI) interface.

28. The system of claim 21, wherein the logic is further operable to receive a call forwarding activation message from the wireless platform when the mobile station is roaming in an agent gatekeeper zone, the call forwarding activation message identifying the roaming number assigned to the mobile station.

29. The system of claim 21, wherein the logic is operable to identify the routing target associated with the destination by accessing a table associating at least one numbering plan with a routing target.

30. The system of claim 21, wherein the wireless platform is associated with a gatekeeper zone served by a gatekeeper other than the home gatekeeper of the mobile station.

31. The system of claim 21, wherein the logic is further operable to:
establish a bearer channel toward the telephone subsystem;
establish a logical channel toward the wireless platform; and
bridge the bearer channel and the logical channel.

32. A gatekeeper for a communication system, comprising:
a memory operable to store an association between at least one numbering plan and a home gatekeeper; and
at least one processor operable to:
receive a registration message from a wireless platform serving a mobile station at a home gatekeeper of the mobile station;
instruct a telephone subsystem to forward a call directed at a telephonic device associated with the mobile station to one of the home gatekeeper of the mobile station and a roaming number assigned to the mobile station;
receive a call setup message at the home gatekeeper of the mobile station, the call setup message representing a call involving the mobile station;
identify a destination of the call using the call setup message and the association information;
identify a routing target associated with the destination; and
communicate the call setup message to the routing target when the home gatekeeper of the mobile station is not a home gatekeeper of the destination.

33. The gatekeeper of claim 32, wherein the routing target comprises one of a network address of the home gatekeeper of the destination and an interface to the telephone subsystem.

34. The gatekeeper of claim 32, wherein the logic is further operable to:
determine if the destination is a registered mobile station when the home gatekeeper of the mobile station is the home gatekeeper of the destination;
communicate the call setup message to the telephone subsystem through a gateway when the destination is not a registered mobile station;
determine if the destination is roaming in an agent gatekeeper zone when the destination is a registered mobile station; and
communicate the call setup message to a wireless platform serving the destination when the destination is not roaming.

35. The gatekeeper of claim 34, wherein the logic is further operable to communicate the call setup message to an agent gatekeeper serving the agent gatekeeper zone when the destination is roaming.

36. The gatekeeper of claim 34, wherein the logic is further operable to:
trigger a call forward to a roaming number assigned to the destination when the destination is roaming; and
communicate the call setup message to the telephone subsystem through a gateway.

37. The gatekeeper of claim 32, wherein the logic is further operable to:
determine if the call setup message represents a mobile-originated call from the mobile station;
determine if the mobile station is roaming in an agent gatekeeper zone; and
communicate the call setup message to an agent gatekeeper serving the agent gatekeeper zone when the call setup message represents a mobile-originated call and the mobile station is roaming.

38. The gatekeeper of claim 32, wherein the logic is operable to instruct the telephone subsystem to forward the call directed at the telephonic device by activating a call forwarding feature in the telephone subsystem using a Computer Telephony Integration (CTI) interface.

39. The gatekeeper of claim 32, wherein the logic is further operable to receive a call forwarding activation message from the wireless platform when the mobile station is roaming in an agent gatekeeper zone, the call forwarding activation message identifying the roaming number assigned to the mobile station.

40. The gatekeeper of claim 32, wherein the wireless platform is associated with a gatekeeper zone served by a gatekeeper other than the home gatekeeper of the mobile station.

41. The gatekeeper of claim 32, wherein the logic is further operable to:
establish a bearer channel toward the telephone subsystem;
establish a logical channel toward the wireless platform; and
bridge the bearer channel and the logical channel.

42. A method for gatekeeper networking, comprising:
receiving a registration message from a wireless platform serving a mobile station at a home gatekeeper of the mobile station;
activating a call forwarding feature in a telephone subsystem using a Computer Telephony Integration (CTI) interface to forward a call directed at a telephonic device associated with the mobile station to the home gatekeeper of the mobile station;
receiving a first call setup message at the home gatekeeper of the mobile station, the first call setup message representing a call originating at the mobile station;
identifying a destination of the call using the first call setup message;
identifying a routing target associated with the destination;
communicating the first call setup message to the routing target when the home gatekeeper of the mobile station is not a home gatekeeper of the destination;
communicating the first call setup message to the telephone subsystem through a gateway when the home gatekeeper of the mobile station is the home gatekeeper of the destination and the destination is not a registered mobile station
communicating the first call setup message to a wireless platform serving the destination when the home gatekeeper of the mobile station is the home gatekeeper of the destination and the destination is a registered non-roaming mobile station;
communicating the first call setup message to a first agent gatekeeper serving a first agent gatekeeper zone when the home gatekeeper of the mobile station is the home gatekeeper of the destination, the destination is a registered mobile station, and the destination is roaming in the first agent gatekeeper zone;
receiving a second call setup message at the home gatekeeper of the mobile station, the second call setup message representing a call directed at the mobile station;
communicating the second call setup message to a second agent gatekeeper serving a second agent gatekeeper zone when the mobile station is roaming in the second agent gatekeeper zone;
communicating the second call setup message to the wireless platform when the mobile station is not roaming; and
communicating the second call setup message to the telephone subsystem through the gateway if the mobile station has deregistered with the home gatekeeper of the mobile station.

43. A method for gatekeeper networking, comprising:
receiving a registration message from a wireless platform serving a mobile station at a home gatekeeper of the mobile station;
receiving a call forwarding activation message from the wireless platform if the mobile station is roaming in an agent gatekeeper zone, the call forwarding activation message identifying a roaming number assigned to the mobile station;
activating a call forwarding feature in a telephone subsystem using a Computer Telephony Integration (CTI) interface to forward a call directed at a telephonic device associated with the mobile station to one of the home gatekeeper of the mobile station and the roaming number assigned to the mobile station;
receiving a first call setup message at the home gatekeeper of the mobile station, the first call setup message representing a call originating at the mobile station;
determining if the mobile station is roaming in the agent gatekeeper zone;
communicating the call setup message to an agent gatekeeper serving the agent gatekeeper zone when the mobile station is roaming;
identifying a destination of the call using the first call setup message;
identifying a routing target associated with the destination;
communicating the first call setup message to the routing target when the home gatekeeper of the mobile station is not a home gatekeeper of the destination;
communicating the first call setup message to the telephone subsystem through a gateway when the home gatekeeper of the mobile station is the home gatekeeper of the destination and the destination is not a registered mobile station;
communicating the first call setup message to a wireless platform serving the destination when the home gatekeeper of the mobile station is the home gatekeeper of the destination and the destination is a registered non-roaming mobile station;
triggering a call forward to a roaming number assigned to the destination and communicating the first call setup message to the telephone subsystem through a gateway when the home gatekeeper of the mobile station is the home gatekeeper of the destination and the destination is roaming;
receiving a second call setup message at the home gatekeeper of the mobile station, the second call setup message representing a call directed at the mobile station;
communicating the second call setup message to the agent gatekeeper when the mobile station is roaming;
communicating the second call setup message to the wireless platform when the mobile station is not roaming; and
communicating the second call setup message to the telephone subsystem through the gateway if the mobile station has deregistered with the home gatekeeper of the mobile station.

44. A system for gatekeeper networking, comprising:
at least one computer processable medium; and
logic encoded on the at least one computer processable medium and operable to:
receive a registration message from a wireless platform serving a mobile station at a home gatekeeper of the mobile station;
activate a call forwarding feature in a telephone subsystem using a Computer Telephony Integration (CTI) interface to forward a call directed at a telephonic device associated with the mobile station to the home gatekeeper of the mobile station;
receive a first call setup message at the home gatekeeper of the mobile station, the first call setup message representing a call originating at the mobile station;
identify a destination of the call using the first call setup message;
identify a routing target associated with the destination;
communicate the first call setup message to the routing target when the home gatekeeper of the mobile station is not a home gatekeeper of the destination;
communicate the first call setup message to the telephone subsystem through a gateway when the home gatekeeper of the mobile station is the home gatekeeper of the destination and the destination is not a registered mobile station
communicate the first call setup message to a wireless platform serving the destination when the home gatekeeper of the mobile station is the home gatekeeper of the destination and the destination is a registered non-roaming mobile station;
communicate the first call setup message to a first agent gatekeeper serving a first agent gatekeeper zone when the home gatekeeper of the mobile station is the home gatekeeper of the destination, the destination is a registered mobile station, and the destination is roaming in the first agent gatekeeper zone;
receive a second call setup message at the home gatekeeper of the mobile station, the second call setup message representing a call directed at the mobile station;
communicate the second call setup message to a second agent gatekeeper serving a second agent gatekeeper zone when the mobile station is roaming in the second agent gatekeeper zone;
communicate the second call setup message to the wireless platform when the mobile station is not roaming; and
communicate the second call setup message to the telephone subsystem through the gateway if the mobile station has deregistered with the home gatekeeper of the mobile station.

45. A system for gatekeeper networking, comprising:
at least one computer processable medium; and
logic encoded on the at least one computer processable medium and operable to:
receive a registration message from a wireless platform serving a mobile station at a home gatekeeper of the mobile station;
receive a call forwarding activation message from the wireless platform if the mobile station is roaming in an agent gatekeeper zone, the call forwarding activation message identifying a roaming number assigned to the mobile station;
activate a call forwarding feature in a telephone subsystem using a Computer Telephony Integration (CTI) interface to forward a call directed at a telephonic device associated with the mobile station to one of the home gatekeeper of the mobile station and the roaming number assigned to the mobile station;
receive a first call setup message at the home gatekeeper of the mobile station, the first call setup message representing a call originating at the mobile station;
determine if the mobile station is roaming in the agent gatekeeper zone;
communicate the call setup message to an agent gatekeeper serving the agent gatekeeper zone when the mobile station is roaming;
identify a destination of the call using the first call setup message;
identify a routing target associated with the destination;
communicate the first call setup message to the routing target when the home gatekeeper of the mobile station is not a home gatekeeper of the destination;
communicate the first call setup message to the telephone subsystem through a gateway when the home gatekeeper of the mobile station is the home gatekeeper of the destination and the destination is not a registered mobile station;
communicate the first call setup message to a wireless platform serving the destination when the home gatekeeper of the mobile station is the home gatekeeper of the destination and the destination is a registered non-roaming mobile station;
trigger a call forward to a roaming number assigned to the destination and communicating the first call setup message to the telephone subsystem through a gateway when the home gatekeeper of the mobile station is the home gatekeeper of the destination and the destination is roaming;
receive a second call setup message at the home gatekeeper of the mobile station, the second call setup message representing a call directed at the mobile station;
communicate the second call setup message to the agent gatekeeper when the mobile station is roaming;
communicate the second call setup message to the wireless platform when the mobile station is not roaming; and
communicate the second call setup message to the telephone subsystem through the gateway if the mobile station has deregistered with the home gatekeeper of the mobile station.

46. A gatekeeper for a communication system, comprising:
a memory operable to store an association between at least one numbering plan and a home gatekeeper; and
at least one processor operable to:
receive a registration message from a wireless platform serving a mobile station at a home gatekeeper of the mobile station;
activate a call forwarding feature in a telephone subsystem using a Computer Telephony Integration (CTI) interface to forward a call directed at a telephonic device associated with the mobile station to the home gatekeeper of the mobile station;
receive a first call setup message at the home gatekeeper of the mobile station, the first call setup message representing a call originating at the mobile station;
identify a destination of the call using the first call setup message and the association information;
identify a routing target associated with the destination;
communicate the first call setup message to the routing target when the home gatekeeper of the mobile station is not a home gatekeeper of the destination;
communicate the first call setup message to the telephone subsystem through a gateway when the home gatekeeper of the mobile station is the home gatekeeper of the destination and the destination is not a registered mobile station
communicate the first call setup message to a wireless platform serving the destination when the home gatekeeper of the mobile station is the home gatekeeper of the destination and the destination is a registered non-roaming mobile station;
communicate the first call setup message to a first agent gatekeeper serving a first agent gatekeeper zone when the home gatekeeper of the mobile station is the home gatekeeper of the destination, the destination is a registered mobile station, and the destination is roaming in the first agent gatekeeper zone;
receive a second call setup message at the home gatekeeper of the mobile station, the second call setup message representing a call directed at the mobile station;
communicate the second call setup message to a second agent gatekeeper serving a second agent gatekeeper zone when the mobile station is roaming in the second agent gatekeeper zone;
communicate the second call setup message to the wireless platform when the mobile station is not roaming; and
communicate the second call setup message to the telephone subsystem through the gateway if the mobile station has deregistered with the home gatekeeper of the mobile station.

47. A gatekeeper for a communication system, comprising:
a memory operable to store an association between at least one numbering plan and a home gatekeeper; and
at least one processor operable to:
receive a registration message from a wireless platform serving a mobile station at a home gatekeeper of the mobile station;
receive a call forwarding activation message from the wireless platform if the mobile station is roaming in an agent gatekeeper zone, the call forwarding activation message identifying a roaming number assigned to the mobile station;
activate a call forwarding feature in a telephone subsystem using a Computer Telephony Integration (CTI) interface to forward a call directed at a telephonic device associated with the mobile station to one of the home gatekeeper of the mobile station and the roaming number assigned to the mobile station;
receive a first call setup message at the home gatekeeper of the mobile station, the first call setup message representing a call originating at the mobile station;
determine if the mobile station is roaming in the agent gatekeeper zone;
communicate the call setup message to an agent gatekeeper serving the agent gatekeeper zone when the mobile station is roaming;
identify a destination of the call using the first call setup message and the association information;
identify a routing target associated with the destination;
communicate the first call setup message to the routing target when the home gatekeeper of the mobile station is not a home gatekeeper of the destination;
communicate the first call setup message to the telephone subsystem through a gateway when the home gatekeeper of the mobile station is the home gatekeeper of the destination and the destination is not a registered mobile station;
communicate the first call setup message to a wireless platform serving the destination when the home gatekeeper of the mobile station is the home gatekeeper of the destination and the destination is a registered non-roaming mobile station;
trigger a call forward to a roaming number assigned to the destination and communicating the first call setup message to the telephone subsystem through a gateway when the home gatekeeper of the mobile station is the home gatekeeper of the destination and the destination is roaming;
receive a second call setup message at the home gatekeeper of the mobile station, the second call setup message representing a call directed at the mobile station;
communicate the second call setup message to the agent gatekeeper when the mobile station is roaming;
communicate the second call setup message to the wireless platform when the mobile station is not roaming; and
communicate the second call setup message to the telephone subsystem through the gateway if the mobile station has deregistered with the home gatekeeper of the mobile station.

48. A method for gatekeeper networking, comprising:
receiving a call setup message at a home gatekeeper of a mobile station, the call setup message representing a call involving the mobile station;
determining whether voice traffic may be transported across a packet network coupled to the home gatekeeper of the mobile station;
identifying a destination of the call using the call setup message;
identifying a routing target associated with the destination, the routing target comprising a network address of a home gatekeeper of the destination if voice traffic may be transported across the packet network and the home gatekeeper of the mobile station is different than the home gatekeeper of the destination, the routing target comprising an interface to the telephone subsystem if voice traffic may not be transported across the packet network and the home gatekeeper of the mobile station is different than the home gatekeeper of the destination; and
communicating the call setup message to the routing target.

49. A gatekeeper for a communication system, comprising:
a memory operable to store an association between at least one numbering plan and a home gatekeeper; and
at least one processor operable to:
receive a call setup message at a home gatekeeper of a mobile station, the call setup message representing a call involving the mobile station;
determine whether voice traffic may be transported across a packet network coupled to the home gatekeeper of the mobile station;
identify a destination of the call using the call setup message;
identify a routing target associated with the destination, the routing target comprising a network address of a home gatekeeper of the destination if voice traffic may be transported across the packet network and the home gatekeeper of the mobile station is different than the home gatekeeper of the destination, the routing target comprising an interface to the telephone subsystem if voice traffic may not be transported across the packet network and the home gatekeeper of the mobile station is different than the home gatekeeper of the destination; and
communicate the call setup message to the routing target.
